(19) United States
(12) Patent Application Publication
(10) Pub. No.: US 2002/0010870 A1
(43) Pub. Date: Jan. 24, 2002

(54) Method and apparatus for dual-band modulation in powerline communication network systems

(76) Inventor: Steven Holmsen Gardner, San Diego, CA (US)

Correspondence Address: Martin J. Jaquez, Esq., JAQUEZ & ASSOCIATES, 750 B Street, Suite 2640, San Diego, CA, 92101, US

(21) Appl. No.: 09/876,734

(22) Filed: Jun. 6, 2001

Related U.S. Application Data
(60) Provisional application No. 60/210,147, filed on Jun. 7, 2000.

(51) Int. Cl. G06F 1/26; G06F 1/28; G06F 1/30

(52) U.S. Cl. 713/300

(57) ABSTRACT

A novel method and apparatus for modulating in dual operational bands in powerline networking systems is described. A transmitter and a receiver are described wherein the transmitter and receiver are operable in different modulation frequency bands. The present invention can easily switch between operational frequency bands by utilizing a fundamental signal for performing modulations in a first frequency band and by utilizing a first alias signal for performing modulations in a second frequency band. The present inventive method and apparatus can switch operation from a first operational frequency band to a second operational frequency band by modifying two components in existing transmitters and only one component in existing OFDM receivers. Advantageously, therefore, the present invention can be utilized with existing powerline networking technology.

### CROSS-REFERENCE TO RELATED PROVISIONAL APPLICATION

This application claims the benefit of U.S. Provisional application Ser. No. 60/210,147, filed Jun. 07, 2000, entitled “Method and Apparatus for Dual-Band Modulation in Powerline Communication Network Systems”, hereby incorporated by reference herein.

### BACKGROUND OF THE INVENTION

1. Field of the Invention

This invention relates to powerline communication networks, and more particularly to a method and apparatus for dual-band modulation in powerline communication network systems.

2. Description of Related Art

The past few years have brought about tremendous changes in the modern home, and especially, in appliances and other equipment designed for home use. For example, advances in personal computing technologies have produced faster, more complex, more powerful, more user-friendly, and less expensive personal computers (PCs) than previous models. Consequently, PCs have proliferated and now find use in a record number of homes. Indeed, the number of multiple-PC homes (households with one or more PCs) is also growing rapidly. Over the next few years, the number of multiple-PC homes is expected to grow at a double-digit rate while the growth from single-PC homes is expected to remain flat. At the same time, the popularity and pervasiveness of the well-known Internet has produced a need for faster and less expensive home-based access.

As is well known, usage of the Internet has exploded during the past few years. More and more often the Internet is the preferred medium for information exchange, correspondence, research, entertainment, and a variety of other communication needs. Not surprisingly, home-based Internet usage has increased rapidly in recent years. A larger number of homes require access to the Internet than ever before. The increase in home Internet usage has produced demands for higher access speeds and increased Internet availability. To meet these needs, advances have been made in cable modem, digital subscriber loop (DSL), broadband wireless, powerline local loop, and satellite technologies. All of these technologies (and others) are presently being used to facilitate home-based Internet access. Due to these technological advances and to the ever-increasing popularity of the Internet, predictions are that home-based Internet access will continue to explode during the next decade. For example, market projections for cable modem and DSL subscriptions alone show an imbedded base of approximately 35 million connected users by the year 2003.

In addition to recent technological advances in the personal computing and Internet access industries, advances have also been made with respect to appliances and other equipment intended for home use. For example, because an increasing number of people work from home, home office equipment (including telecommunication equipment) has become increasingly complex and sophisticated. Products have been developed to meet the needs of the so-called SOHO (“small office, home office”) consumer. While these SOHO products tend to be less expensive than their corporate office product counterparts, they do not lack in terms of sophistication or computing/communication power. In addition to the increasing complexity of SOHO products, home appliances have also become increasingly complex and sophisticated. These so-called “smart” appliances often use imbedded microprocessors to control their functions. Exemplary smart appliances include microwaves, refrigerators, dishwashers, washing machines, dryers, ovens, etc. Similar advances have been made in home entertainment systems and equipment such as televisions (including set-top boxes), telephones, videocassette recorders (VCRs), stereos, etc. Most of these systems and devices include sophisticated control circuitry (typically implemented using microprocessors) for programming and controlling their functions. Finally, many other home use systems such as alarm systems, irrigation systems, etc., have been developed with sophisticated control sub-components.

The advances described above in home appliance and equipment technologies have produced a need for similar advancements in home communication networking technology. As home appliances and entertainment products become increasingly more complex and sophisticated, the need has arisen for facilitating the interconnection and networking of the home appliances and other products used in the home. One proposed home networking solution is commonly referred to as “Powerline Networking”. Powerline networking refers to the concept of using existing residential AC power lines as a means for networking all of the appliance and products used in the home. Although the existing AC power lines were originally intended for supplying AC power only, the Powerline Networking approach anticipates also using the power lines for communication networking purposes. One such proposed powerline networking approach is shown in the block diagram of FIG. 1.

As shown in FIG. 1, the powerline network 100 comprises a plurality of power line outlets 102 electrically coupled to one another via a plurality of power lines 104. As shown in FIG. 1, a number of devices and appliances are coupled to the powerline network via interconnection with the plurality of outlets 102. For example, as shown in FIG. 1, a personal computer 106, laptop computer 108, telephone 110, facsimile machine 112, and printer 114 are networked together via electrical connection with the power lines 104 through their respective and associated power outlets 102. In addition, “smart” appliances such as a refrigerator 115, washer dryer 116, microwave 118, and oven 126 are also networked together using the proposed powerline network 100. A smart television 122 is networked via electrical connection with its respective power outlet 102. Finally, as shown in FIG. 1, the powerline network can access an Internet Access Network 124 via connection through a modem 126 or other Internet access device.

With multiple power outlets 102 in almost every room of the modern home, the plurality of power lines 104 potentially comprise the most pervasive in-home communication network in the world. The powerline network system is available anywhere power lines exist (and therefore, for all intents and purposes, it has worldwide availability). In addition, networking of home appliances and products is potentially very simple using powerline networking systems. Due to the potential ease of connectivity and installation, the powerline networking approach will likely be very attractive to the average consumer. However, powerline networking systems presents a number of difficult technical challenges. In order for powerline networking systems to gain acceptance these challenges will need to be overcome.

To appreciate the technical challenges presented by powerline networking systems, it is helpful to first review some of the electrical characteristics unique to home powerline networks. As is well known, home power lines were not originally designed for communicating data signals. The physical topology of the home power line wiring, the physical properties of the electrical cabling used to implement the power lines, the types of appliances typically connected to the power lines, and the behavioral characteristics of the current that travels on the power lines all combine to create technical obstacles to using power lines as a home communication network.

The power line wiring used within a house is typically electrically analogous to a network of transmission lines connected together in a large tree-like configuration. The power line wiring has differing terminating impedances at the end of each stub of the network. As a consequence, the transfer function of the power line transmission channel has substantial variations in gain and phase across the frequency band. Further, the transfer function between a first pair of power outlets is very likely to differ from that between a second pair of power outlets. The transmission channel tends to be fairly constant over time. Changes in the channel typically occur only when electrical devices are plugged into or removed from the power line (or occasionally when the devices are powered on/off). When used for networking devices in a powerline communications network, the frequencies used for communication typically are well above the 60-cycle AC power line frequency. Therefore, the desired communication signal spectrum is easily separated from the real power-bearing signal in a receiver connected to the powerline network.

Another important consideration in the power line environment is noise and interference. Many electrical devices create large amounts of noise on the power line. The powerline networking system must be capable of tolerating the noise and interference present on home power lines. Some of the home power line interference is frequency selective. Frequency selective interference causes interference only at specific frequencies (i.e., only signals operating at specific frequencies are interfered with, all other signals experience no interference). However, in addition, some home power line interference is impulsive by nature. Although impulsive interference spans a broad range of frequencies, it occurs only in short time bursts. Some home power line interference is a hybrid of these two (frequency selective and impulsive). In addition to the different types of interference present on the home power lines, noise is neither uniform nor symmetrical across the power lines. For example, noise proximate a first device may cause the first device to be unable to receive data from a second, more distant device; however, the second device may be able to receive data from the first. The second device may be able to receive information from the first because the noise at the receiver of the second device is attenuated as much as is the desired signal in this case. However, because the noise at the receiver of the first device is not as attenuated as is the desired signal (because the noise source is much closer to the first device than the second), the first device will be unable to receive information from the second.

Another consideration unique to powerline networking systems is that home power line wiring typically does not stop at the exterior wall of a house. Circuit breaker panels and electric meters (typically located outside the home) pass frequencies used for home networking. In typical residential areas, a local power transformer is used to regulate voltage for a fairly small number of homes (typically between 5 and 10 homes). These homes all experience relatively small amounts of attenuation between each other. The signal frequencies of interest to powerline networking systems do not tend to pass through the transformer. Due to these electrical characteristics, signals generated in a first home network can often be received in a second home network, and vice versa. In addition, unlike internal dedicated Ethernet or other data networks, power lines are accessible from power outlets outside of the home. This raises obvious security concerns because users typically do not want to share information with unauthorized users including their neighbors.

Signals that travel outside of the house tend to encounter greater attenuation than those that originate in the same house, and thus the percentage of outlets having house-to-house connectivity is much lower than the percentage for same house connectivity. The fact that transmissions at some outlets may not be receivable at other outlets is a significant difference between powerline networking systems and a wired LAN-type communication network such as the well-known Ethernet.

Despite these and other technical concerns, powerline communication network systems are presently being developed and proposed. For example, the HomePlug™ Powerline Alliance has proposed one such powerline communication network. The HomePlug™ Powerline Alliance is a non-profit industry association of high technology companies. The association was created to foster an open specification for home powerline networking products and services. Once an open specification is adopted, the association contemplates encouraging global acceptance of solutions and products that employ it.

A very important aspect of any home powerline networking system specification is the definition of a modulation protocol used by the powerline networking systems to efficiently transmit information between transmitters and receivers. For a better understanding of modulation protocols used in powerline networks, a basic powerline networking system transmitter and receiver are now described with reference to FIGS. 2a and 2b.

FIG. 2a shows a simplified block diagram of a basic powerline networking transmitter 30. As shown in FIG. 2a, the basic powerline networking transmitter 30 comprises a data source 32, a modulation operations stage 34 and a line driver and power line coupler stage 36. The data source 32 outputs either an analog or digital data signal (depending on the networking system used) to the input of the modulation operations stage 34. The modulation operations stage 34 outputs a modulated signal to the line driver and power line coupler stage 36. The line driver and power line coupler stage 36 outputs an amplified modulated signal to a network (e.g., power lines).

FIG. 2b shows a simplified block diagram of a basic powerline networking receiver 40. As shown in FIG. 2b, the basic powerline networking receiver 40 comprises a power line coupler and AGC (automatic gain control) stage 42, a demodulation operations stage 44 and a data sink 46. The power line coupler and AGC stage 42 obtain inputs from a modulated signal (not shown) from a powerline network and outputs the modulated signal to the input of the demodulation operations stage 44. The demodulation operations stage 44 demodulates the modulated signal and outputs a data signal to the input of the data sink 46. The demodulation technique used by the demodulation operations stage 44 of the basic powerline networking receiver 40 depends upon the modulation technique utilized by the modulation operations stage 34 of the basic powerline networking transmitter 30.

Referring again to FIG. 2a, the modulation operations stage 34 of the basic powerline networking transmitter 30 modulates the data signal by performing a series of operations to the data signal. These operations are also known as a modulation techniques performed on the signals. Modulation techniques are well known in the digital communications art. Examples of modulation techniques include amplitude modulation (AM) and frequency modulation (FM). The type of modulation techniques utilized in the modulation operations stage 34 depends upon the operating environment of the networking system.

In powerline networks, power line channels are highly frequency-selective, with both the gain and the phase of the channels varying substantially over the frequency band. Thus, single carrier modulation techniques are ill suited for powerline networks because they require complex adaptive equalizers necessary to compensate for the channel. Consequently, multi-carrier modulation (MCM) techniques are well suited for powerline networking systems.

Orthogonal Frequency Division Multiplexing (OFDM) is one MCM technique that is well suited for powerline networking systems. OFDM is well suited for powerline networking environments because with multiple carriers being used, the channel is essentially flat across the band of each carrier. Advantageously, no equalization is required in order to recover a signal when individual carriers use differential phase modulation.

OFDM modulation techniques are well known in the modulation design art as exemplified by their description in an article entitled “Multicarrier Modulation for Data Transmission: An Idea Whose Time Has Come”, by John A. C. Bingham, published in IEEE Communications Magazine at pages 5-14, in May 1990 which is hereby fully incorporated by reference herein for its teachings on data transmission and modulation techniques. Typical OFDM systems generate transmitted waveforms using Inverse Fast-Fourier Transforms (IFFT). The modulation of each carrier uses rectangular pulses, and thus, the entire OFDM time domain waveform can be created by simply setting an appropriate amplitude and phase for the points in the frequency domain that correspond to each carrier, and by implementing the IFFT to create a time domain waveform.

One important characteristic of OFDM modulation techniques is that the carriers are “orthogonal”. The carriers are orthogonal because each carrier has an integer number of periods in the time interval that is generated by the IFFT. This orthogonal characteristic of OFDM modulation allows OFDM receivers to perform an FFT that yields the original data bits without creating intersymbol interference.

OFDM modulation techniques transmit data by dividing a data stream into several parallel bit streams. The bit-rate of each of these bit streams is much lower than the aggregate bit-rate of all the streams. These bit streams are used to modulate several densely spaced and overlapping sub-carriers. Although the sub-carriers overlap in frequency spectrum, their orthogonal relation allows separation for demodulation purposes. OFDM is the proposed modulation technique for the powerline communication network proposed by the HomePlug™ Powerline Alliance. In the HomePlug™ powerline networking system, OFDM carriers are frequency-spaced at 50/256 MHz (i.e., 195,313 Hz) starting at the origin. Thus, the n^{th} carrier occurs at 50 n/256 MHz. The HomePlug™ powerline network systems contemplated for use in the U.S.A. market use carriers from n=23 to n=106 inclusive, or carriers at frequencies from 4.49 MHz to 20.7 MHz. In the U.S.A., the HomePlug™ powerline network systems operate at frequencies below 25 MHz.

One prior art OFDM modulation approach contemplated for use with the HomePlug™ powerline networking systems uses a powerline networking transmitter, having an OFDM modulation operations stage, and a powerline networking receiver, having an OFDM demodulation operations stage. The prior art OFDM powerline transmitter is now described with reference to FIG. 3.

FIG. 3 shows a simplified block diagram of a prior art OFDM powerline transmitter 300 contemplated for use with the proposed HomePlug™ powerline network system. As shown in FIG. 3, the OFDM powerline transmitter 300 comprises a digital data source 302, a modulation operations stage (implemented by the processing blocks 304-320) and a line driver and power line coupler stage 330. The digital data source 302 outputs a digital bitstream to the input of a serial to parallel converter 304.

The serial-to-parallel converter 304 converts the digital bitstream into a series of parallel words wherein each parallel word comprises complex values. For example, in a QPSK modulation scheme where all frequency tones are used, 168 bits of the digital bitstream converts into a single word of 84 complex values. Each complex value ultimately imposes one of four phases on one of the carriers in the OFDM carrier set. The serial-to-parallel converter 304 outputs each parallel word to the input of the weighting stage 306.

The weighting stage 306 performs amplitude weighting on the complex values of each parallel word. Weighting is well known in the modulation art, and thus, is not described in more detail herein. Each carrier potentially can be weighted differently. Weighting can be applied for various reasons such as for providing power control (if applied to all of the values equally). Another reason that weighting might be applied is for creating a shaping of the transmit spectrum. In powerline networking systems, it is desirable to weight the complex values to compensate for the response of a digital-to-analog converter 314 (described hereinbelow). As is well known, digital-to-analog converters produce an output response having the form of “sin(x)/x”. As shown in FIG. 3, the weighting stage 306 outputs weighted complex values to the input of the Inverse Fast Fourier transform (IFFT) stage 308.

To ensure that output waveform samples are formed properly, the IFFT stage 308 arranges the weighted complex values within an associated frequency word. A frequency word can be defined as a set of tone positions. The number of tone positions used depends upon the size of the frequency word. In powerline networking, each frequency word comprises 256 tone positions. Different types of data values are assigned to various respective and associated tone positions. For example, in one system the complex values assigned to tone positions n=0 to 22 inclusive are set to zero. The weighted complex values are assigned the tone positions from n=23 to 106 inclusive. Zero values are assigned to the word positions from n=107 to 128 (i.e., these positions are zero filled). To ensure creation of a real-valued waveform, the complex conjugate of the value at position 256-n is assigned to word positions from n=128 to 255. As is well known in the modulation design art, the sign of the imaginary part of a complex value can be inverted to produce its complex conjugate. After arranging the frequency word, the IFFT stage 308 computes an inverse fast Fourier transform in a well-known manner, and thereby transforms the frequency word into a time-domain waveform having a length of 256 samples. The IFFT stage 308 outputs the time-domain waveform to the input of the add cycle prefix stage 310.

The add cycle prefix stage 310 lengthens the time-domain waveform by adding a “cyclic prefix” to the waveform. The cyclic prefix is used to reduce the effects of multi-path interference during transmission. One method of adding a cyclic prefix is accomplished by taking a number of samples from the end of the time-domain waveform and reproducing them at the beginning of the waveform. For example, the last 164 samples of the time-domain waveform is replicated and placed at the beginning of the waveform. Thus, the total waveform length including the prefix is 420 samples (246+164). The add cycle prefix stage 310 outputs the prefixed-added waveforms to the inputs of the parallel-to-serial converter 312.

The parallel-to-serial converter 312 converts the prefixed-added waveforms to a serial waveform. In one embodiment, the data rate of the serial waveform is 50 MHz. Referring again to FIG. 3, the parallel-to-serial converter 312 outputs the serial waveform to the input of the digital-to-analog converter 314.

The digital-to-analog (D/A) converter 314 converts the serial waveform to a serial analog waveform. One well-known phenomenon that results from the conversion of a digital bitstream (e.g., the serial waveform) to an analog signal (e.g., the serial analog waveform) using D/A converters is the production of “aliases”. Aliases are defined herein as frequency-shifted copies of the fundamental frequency spectrum of an input signal centered at multiples of the D/A sampling frequency. When the D/A converter 314 is designed to hold each sample level for a full sample clock period, the set of frequency-shifted aliases are weighted by a sin(x)/x response. The sin(x)/x response has its nulls at multiples of the D/A sampling frequency.

In the powerline networking system proposed by the HomePlug™ Alliance for the U.S.A. market, modulation is accomplished using only the fundamental signal, which falls roughly between 4.5 to 20.7 MHz as described above. However, the D/A converter 314 outputs unwanted aliases of the fundamental signal. The first unwanted alias begins at approximately 29.3 MHz and extends upward to approximately 45.5 MHz. Other unwanted aliases having frequencies that are higher than the first unwanted alias are also generated. For example, the second unwanted alias begins at approximately 54.5 MHz and extends upward to approximately 70.7 MHz. In order to reduce or eliminate these unwanted aliases from being propagated through the transmitter, an anti-aliasing low-pass filter 320 is placed after the D/A converter 314. Thus, the D/A converter 314 outputs a serial analog waveform (containing the fundamental signal and unwanted aliases) of the signal, and provide this signal as input to a low-pass anti-alias filter 320.

As shown in FIG. 3, the low-pass anti-alias filter 320 outputs only the fundamental signal (i.e., frequencies of the signal between 4.5 and 20.7 MHz). The low-pass anti-alias filter 320 blocks other signals (e.g., unwanted aliases) from being output to a line driver and power coupler stage 330. The low-pass anti-alias filter 320 outputs the fundamental signal to the input of the line driver and power coupler stage 330. The line driver and power coupler stage 330 amplifies the fundamental signal and couples the signal to a powerline network. To demodulate data contained in the fundamental signal, a powerline networking receiver having OFDM demodulation capabilities is detachably coupled to the power line wire. A prior art OFDM powerline receiver is now described with reference to FIG. 4.

FIG. 4 shows a simplified block diagram of a prior art OFDM powerline receiver 400 for use with the powerline networking system being proposed by the HomePlug™ Alliance. As shown in FIG. 4, the OFDM powerline receiver 400 comprises a power line coupler and AGC (automatic gain control) stage 402, a demodulation operations stage (comprising the processing blocks 410-426) and a data sink 428. The power line coupler and AGC stage 402 couples the powerline network (described above) to the receiver 400 and the AGC amplifies an input signal across a predetermined dynamic frequency range. If the dynamic frequency range of the receiver 400 is adequate an AGC may not be needed. The power line coupler and AGC stage 402 outputs an analog waveform to a low-pass anti-alias filter 410 as shown in FIG. 4.

The low-pass anti-alias filter 410 prevents unwanted signal content to be generated when the analog waveform is converted from the analog domain to the digital domain (A/D). During analog-to-digital conversion, a signal sampled by an A/D converter typically produces signal content at each frequency of the sampled signal. The sampled signal content at each frequency contains the sum of the signal content at each frequency in the analog waveform, the signal content of the current frequency and the signal content of all multiples of the sampling rate used by the A/D converter. Usually the signal content of the current frequency and the signal content of all multiples of the sampling rate produce interference. Thus, to prevent degradation of the desired signal, an anti-alias filter is typically used to suppress signal energy that might “fold” (ie., mix) into the desired band. The anti-alias filter reduces this signal energy to an acceptable level. The output of the low-pass anti-alias filter 410 is input to an analog-to-digital (A/D) converter 420. The A/D converter 420 converts the analog waveform to a digital sample stream. As shown in FIG. 4, the A/D converter 420 outputs the digital sample stream to the input of a serial-to-parallel (S/P) converter 422.

The S/P converter 422 converts the digital sample stream into a parallel set of samples as shown in FIG. 4. A timing step (not shown in FIG. 4) is required for determining when to apply the serial-to-parallel conversion to the digital sample stream. The S/P converter 422 outputs the parallel set of samples to the input of a fast Fourier Transform (FFT) stage 424. The FFT 424 computes a fast Fourier transform in a well-known manner to produce frequency domain values. The frequency domain values are produced as input, to a parallel-to-serial (P/S) converter 426. The P/S converter 426 converts the parallel input signals to a serial signal. The P/S converter 426 provides the serial signal as input to the data sink 428. The data sink 428 is used to extract a receiver estimate of the data source of the transmitter 300.

The HomePlug™ Alliance powerline networking system proposed for use in the United States operates within a frequency band of between 4-25 MHz. The proposed U.S. powerline networking system is being designed to operate in this frequency band for two principal reasons. First, federal regulatory requirements in this frequency band allow for signal generation at power levels that are sufficiently large as to provide good connectivity. Second, signals within this frequency band will encounter less attenuation than signals operating within higher frequency bands.

In Europe and other foreign countries, the frequency band proposed for a U.S. market (4-25 MHz) may not be desirable. In Europe, power companies have proposed using powerline networking in the 4-25 MHz frequency band for providing Internet access. Internet access signals operate in the high frequency range. In powerline networks, these access signals must be applied at the transformer because the transformer that feeds individual houses blocks high frequency signals. In Europe, Internet access through the powerline networks is economically viable because a single transformer typically supplies as many as 100 homes. In contrast, the economic viability of supplying Internet access using power lines within the U.S. is less because a single transformer typically supplies only between 5-10 homes. Thus, in Europe, strong economic forces favor reserving the 4-25 MHz frequency band for Internet access technologies. Therefore, powerline network systems in Europe are intended to operate at frequency bands greater than 25 MHz.

Disadvantageously, existing OFDM transmitters are designed to generate only within one frequency band (e.g., 4-25 MHz). Thus, existing OFDM transmitters designed to operate in the U.S. market (i.e., 4-25 MHz) cannot operate in Europe due to the different operational frequency bands. Similarly, existing OFDM transmitters that are designed to operate in Europe are not compatible with U.S. operation.

Therefore, a need exists for a method and apparatus for dual-band modulation in powerline communication network systems. Specifically, a need exists for a method and apparatus for powerline network transmitters and receivers that can operate within a frequency band below 25 MHz (for use in the U.S.) and within a frequency band above 25 MHz (for use in Europe and other countries). Such a method and apparatus should be implemented easily and cost effectively with existing technology. The present invention provides such a dual-band modulation method and apparatus.

### SUMMARY OF THE INVENTION

The present invention is a method and apparatus for performing dual-band modulation in powerline networking systems. The present invention can easily be utilized with existing powerline technology. The inventive method and apparatus utilizes a transmitter and a receiver that can operate in different modulation frequency bands. The present invention takes advantage of the well-known phenomenon of “frequency aliases” that are typically produced during digital-to-analog processes. The present invention can easily switch frequency bands by utilizing a fundamental signal for modulating a first frequency band and a first alias signal for modulating a second frequency band.

The present inventive method and apparatus can switch operation from a first frequency band to a second frequency band by slightly modifying two components in an inventive OFDM transmitter and one component in an inventive OFDM receiver. In one embodiment designed to operate in frequency bands below 25 MHz, the inventive OFDM transmitter includes a low-pass anti-aliasing filter and a first set of weighting values. In this embodiment, the inventive OFDM receiver includes a low-pass anti-aliasing filter. When operating in frequency bands above 25 MHz, the inventive OFDM transmitter includes a band-pass anti-aliasing filter and a second set of weighting values. In this embodiment, the inventive OFDM receiver includes a band-pass anti-aliasing filter.

### BRIEF DESCRIPTION OF THE DRAWINGS

FIG. 1 is a block diagram of an exemplary powerline network.

FIG. 2a is a simplified block diagram of a baseline powerline networking transmitter.

FIG. 2b is a simplified block diagram of a baseline powerline networking receiver.

FIG. 3 is a simplified block diagram of a prior art OFDM powerline transmitter.

FIG. 4 is a simplified block diagram of a prior art OFDM powerline receiver.

FIG. 5a is a simplified block diagram of one embodiment of an OFDM transmitter in accordance with the present invention.

FIG. 5b is an alternative embodiment of the present inventive OFDM transmitter in accordance with the present invention.

FIG. 6 is a graph showing the D/A converter low band response, location of high band carrier set tones and low band correction gain to be applied for weighting purposes.

FIG. 7 is a graph showing the D/A converter high band response, location of high band carrier set tones and high band correction gain to be applied for weighting purposes.

FIG. 8a is a simplified block diagram of one embodiment of an OFDM powerline receiver in accordance with the present invention.

FIG. 8b is an alternative embodiment of the present inventive OFDM receiver in accordance with the present invention.

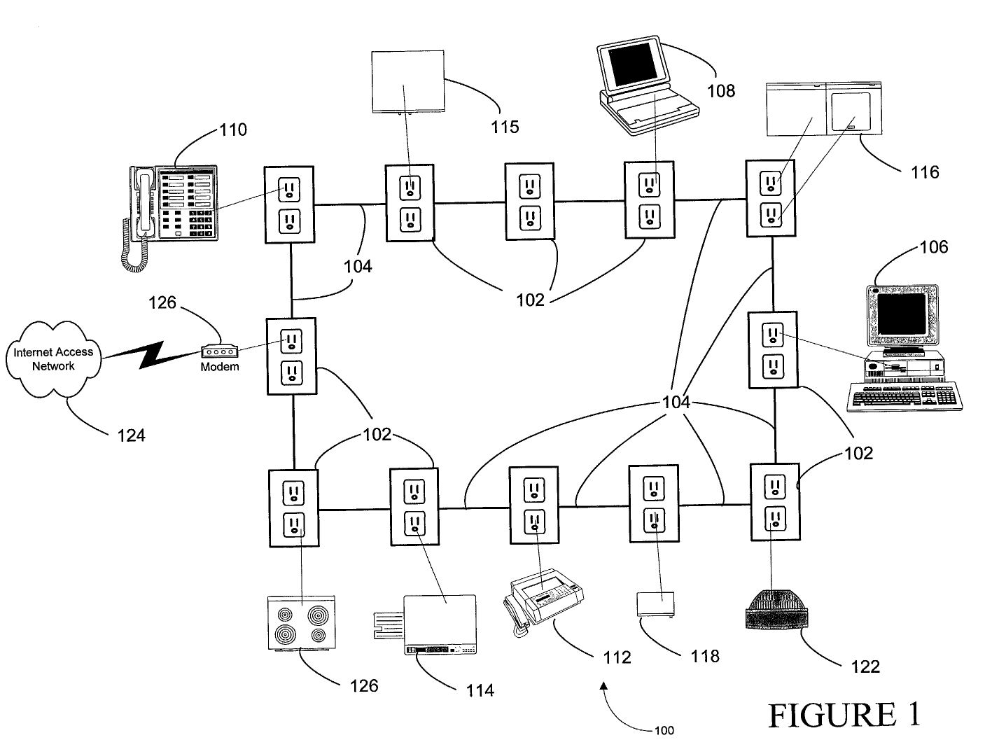

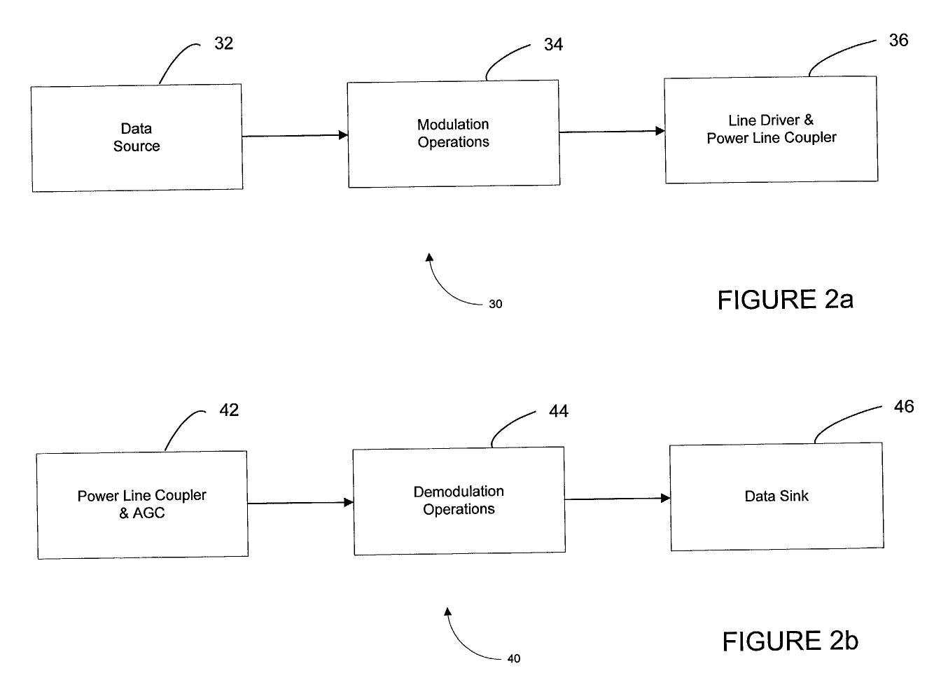

Like reference numbers and designations in the various drawings indicate like elements.

### DETAILED DESCRIPTION OF THE INVENTION

Throughout this description, the preferred embodiment and examples shown should be considered as exemplars, rather than as limitations on the present invention.

The present invention is a method and apparatus for dual-band modulation in powerline networking systems. The present invention can be easily utilized with existing powerline networking technology. The inventive method and apparatus utilizes a transmitter and a receiver that can operate in different modulation frequency bands with little modification. The present invention can easily switch between operating frequency bands by utilizing a fundamental signal for modulating a first frequency band and a first alias signal for modulating a second frequency band. In one embodiment, the fundamental signal modulates frequency bands below 25 MHz (e.g., between 4-25 MHz for the U.S. operating frequency band) while the first alias signal modulates frequency bands above 25 MHz (e.g., greater than 25 MHz for the European frequency band).

The present inventive method and apparatus can switch operation from a first frequency band to a second frequency band by slightly modifying two components in existing OFDM transmitters and by modifying only one component in existing OFDM receivers. In one embodiment, designed to operate in frequency bands below 25 MHz, the inventive OFDM transmitter includes a low-pass anti-aliasing filter and a first set of weighting values. The inventive OFDM receiver includes a low-pass anti-aliasing filter. For operating in frequency bands above 25 MHz, the inventive OFDM transmitter includes a band-pass anti-aliasing filter and a second set of weighting values. The inventive OFDM receiver includes a band-pass anti-aliasing filter. One embodiment of the inventive OFDM transmitter for use with the present invention is now described.

OFDM Transmitter

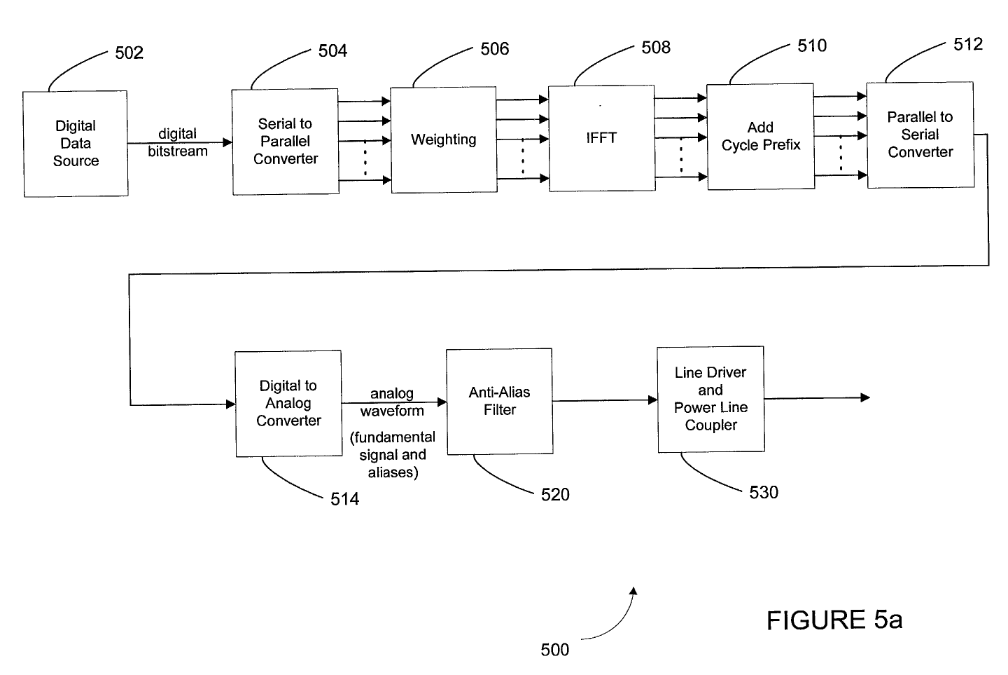

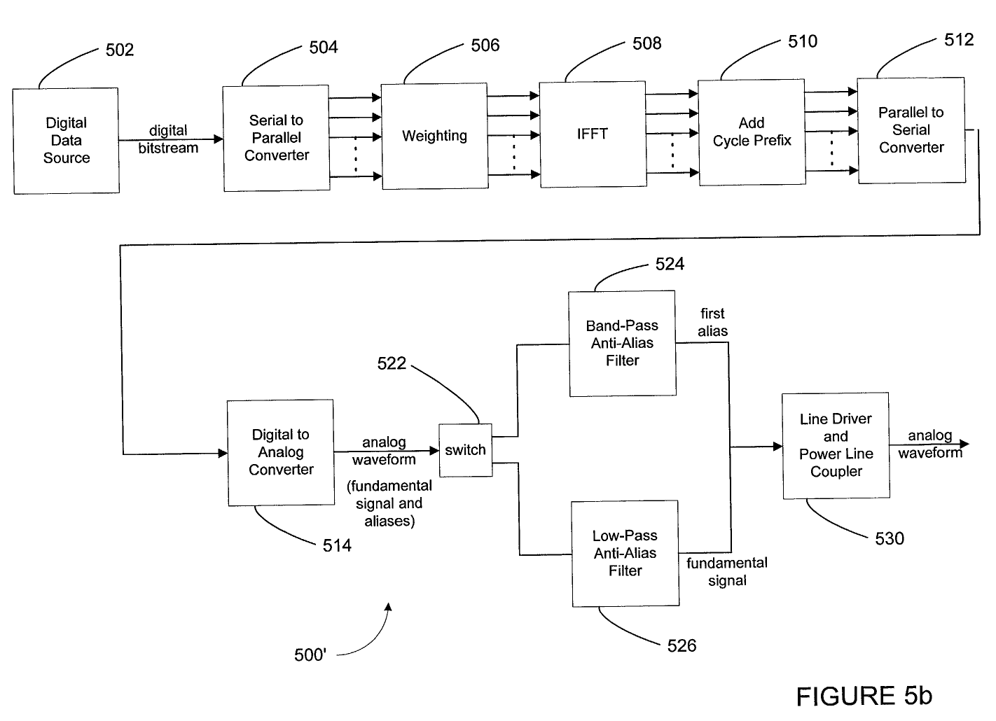

FIG. 5a shows a simplified block diagram of one embodiment of an OFDM transmitter made in accordance with the present invention. As shown in FIG. 5a, the OFDM transmitter 500 comprises a digital data source 502, a modulation operations stage (comprising the processing blocks 504-520), and a line driver/power line coupler stage 530. The digital data source 502 outputs a digital bitstream to the input of a serial-to-parallel converter 504.

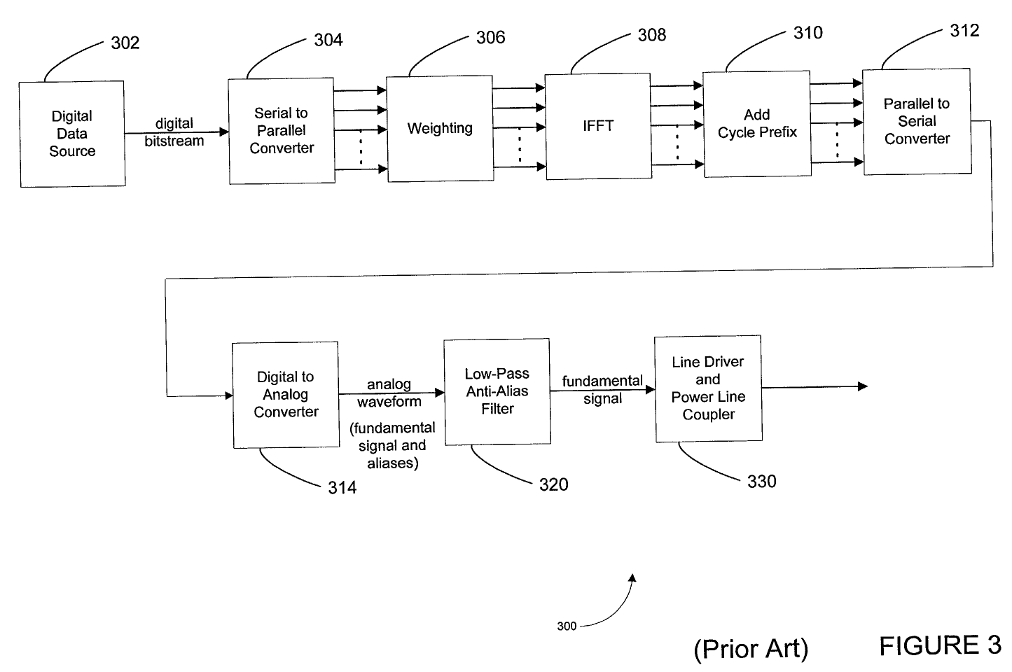

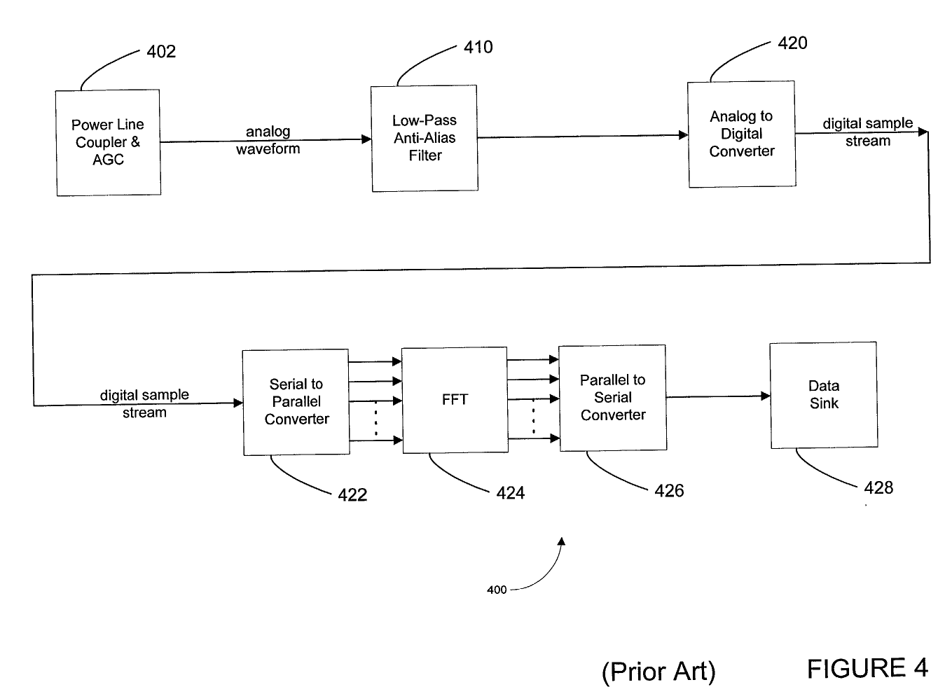

As described above with reference to FIG. 3, the serial to parallel converter 504 converts the digital bitstream into a series of parallel words wherein each parallel word includes complex values. In one embodiment, a QPSK modulation scheme utilizing all frequency tones preferably converts 168-bit blocks of the digital bitstream into single words comprising 84 complex values each. The QPSK modulation scheme, block bit values and word values are not meant to limit the present invention as one skilled in the art shall recognize that different modulation schemes and values can be used without departing from the spirit or the scope of the present invention. In the present invention each complex value ultimately imposes one of four phases on one of the carriers in the OFDM carrier set. The serial-to-parallel converter 504 outputs each parallel word to an input of the weighting stage process 506.

The weighting stage process 506 performs amplitude weighting on the complex values of each parallel word. Weighting techniques are well known in the modulation art, and thus, are not described in more detail herein. Each carrier can potentially be weighted differently. Weighting can be applied for various reasons such as for providing power control (if applied to all values equally). Another motivation for applying weighting is to shape the transmit frequency spectrum. In powerline networking, weighting of the complex values is desirable in order to compensate for the response generated by the digital-to-analog (D/A) converter 514 (described hereinbelow), which in one embodiment produces a sin(x)/x response. The weighting that is used depends upon the frequency band being utilized in the OFDM transmitter 500 because the D/A converter 514 responses are frequency-dependent. Thus, in a dual-band OFDM transmitter, a first set of weighting values is used for operating within a first frequency band, and a second set of weighting values is used for operating within a second frequency band.

In one embodiment of the present inventive OFDM transmitter 500, a first set of weighting values is used for operating within a “low” frequency band, and a second set of weighting values is used for operating within a “high” frequency band. In this embodiment, the low band is defined herein as frequency bands below 25 MHz (e.g., the 4-25 MHz U.S. operating frequency band), and the high band is defined herein as frequency bands above 25 MHz (e.g., the greater than 25 MHz European operating frequency band). Table 1 (shown below) contains exemplary low band and high band weighting values for use with the transmitter 500 of FIG. 5a.

TABLE 1
Weights used for Correction of the D/A Response

| | low band | high band | tone | low band | high band |
|---|---|---|---|---|---|
| tone # | weight | weight | # | weight | weight |
| 23 | 1.01 | 10.27 | 65 | 1.11 | 3.27 |
| 24 | 1.01 | 9.81 | 66 | 1.12 | 3.22 |
| 25 | 1.02 | 9.39 | 67 | 1.12 | 3.17 |
| 26 | 1.02 | 9.00 | 68 | 1.13 | 3.11 |
| 27 | 1.02 | 8.64 | 69 | 1.13 | 3.06 |
| 28 | 1.02 | 8.31 | 70 | 1.13 | 3.01 |
| 29 | 1.02 | 8.00 | 71 | 1.14 | 2.97 |
| 30 | 1.02 | 7.71 | 72 | 1.14 | 2.92 |
| 31 | 1.02 | 7.44 | 73 | 1.15 | 2.88 |
| 32 | 1.03 | 7.18 | 74 | 1.15 | 2.83 |
| 33 | 1.03 | 6.95 | 75 | 1.16 | 2.79 |
| 34 | 1.03 | 6.72 | 76 | 1.16 | 2.75 |
| 35 | 1.03 | 6.51 | 77 | 1.17 | 2.71 |
| 36 | 1.03 | 6.31 | 78 | 1.17 | 2.67 |
| 37 | 1.04 | 6.13 | 79 | 1.18 | 2.63 |
| 38 | 1.04 | 5.95 | 80 | 1.18 | 2.60 |
| 39 | 1.04 | 5.78 | 81 | 1.19 | 2.56 |
| 40 | 1.04 | 5.62 | 82 | 1.19 | 2.53 |
| 41 | 1.04 | 5.47 | 83 | 1.20 | 2.49 |
| 42 | 1.05 | 5.33 | 84 | 1.20 | 2.46 |
| 43 | 1.05 | 5.19 | 85 | 1.21 | 2.43 |
| 44 | 1.05 | 5.06 | 86 | 1.21 | 2.40 |
| 45 | 1.05 | 4.94 | 87 | 1.22 | 2.37 |
| 46 | 1.06 | 4.82 | 88 | 1.22 | 2.34 |
| 47 | 1.06 | 4.70 | 89 | 1.23 | 2.31 |
| 48 | 1.06 | 4.59 | 90 | 1.24 | 2.28 |
| 49 | 1.06 | 4.49 | 91 | 1.24 | 2.25 |
| 50 | 1.07 | 4.39 | 92 | 1.25 | 2.23 |
| 51 | 1.07 | 4.29 | 93 | 1.26 | 2.20 |
| 52 | 1.07 | 4.20 | 94 | 1.26 | 2.17 |
| 53 | 1.07 | 4.11 | 95 | 1.27 | 2.15 |
| 54 | 1.08 | 4.03 | 96 | 1.28 | 2.13 |
| 55 | 1.08 | 3.95 | 97 | 1.28 | 2.10 |
| 56 | 1.08 | 3.87 | 98 | 1.29 | 2.08 |
| 57 | 1.09 | 3.79 | 99 | 1.30 | 2.06 |
| 58 | 1.09 | 3.72 | 100 | 1.30 | 2.03 |
| 59 | 1.09 | 3.65 | 101 | 1.31 | 2.01 |
| 60 | 1.10 | 3.58 | 102 | 1.32 | 1.99 |
| 61 | 1.10 | 3.52 | 103 | 1.33 | 1.97 |
| 62 | 1.10 | 3.45 | 104 | 1.33 | 1.95 |
| 63 | 1.11 | 3.39 | 105 | 1.34 | 1.93 |
| 64 | 1.11 | 3.33 | 106 | 1.35 | 1.91 |

To facilitate a better understanding of the derived weighting values, a brief description of tone positioning and D/A converter response is now presented. Tone positioning refers to the process of assigning complex values to corresponding tone positions. One method of tone positioning is described above with respect to the IFFT stage 308 (FIG. 3). In one embodiment of the present invention, low band tone positions range from position 0 to position 127. In this embodiment, high band tone positions range from position 128 to position 256. As described above, the weighting of complex values depends on the response of the D/A converter 514. Graphs depicting the D/A converter response for low band and high band operation are now described.

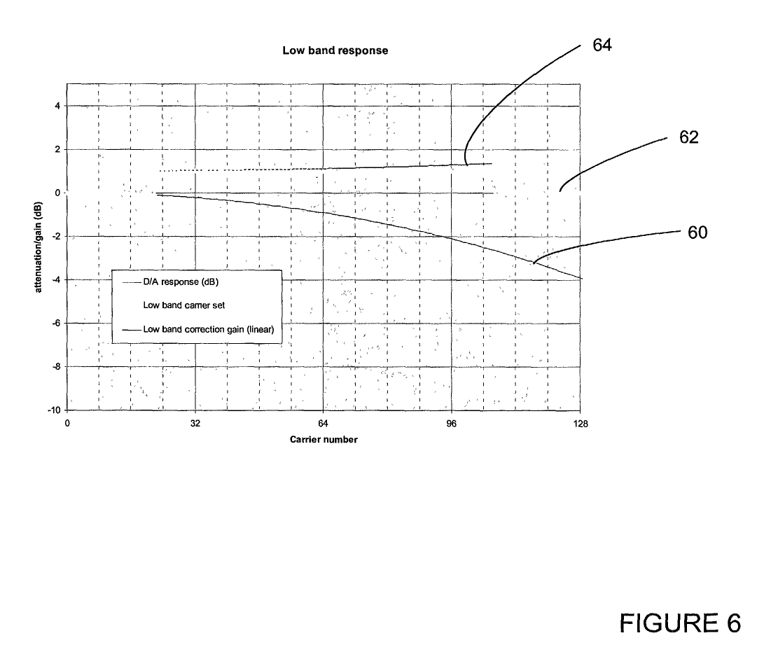

FIG. 6 is a graph showing the D/A converter low band response 60 (in decibels), location of high band carrier set tones 62 and a low band correction gain 64 to be applied for weighting purposes. The low band correction gain 64 shows the gain compensation that can be performed by the weighting stage 506 to compensate for the low band response 60. This weighting can be performed to equalize the power levels of all carriers at the D/A converter output 514.

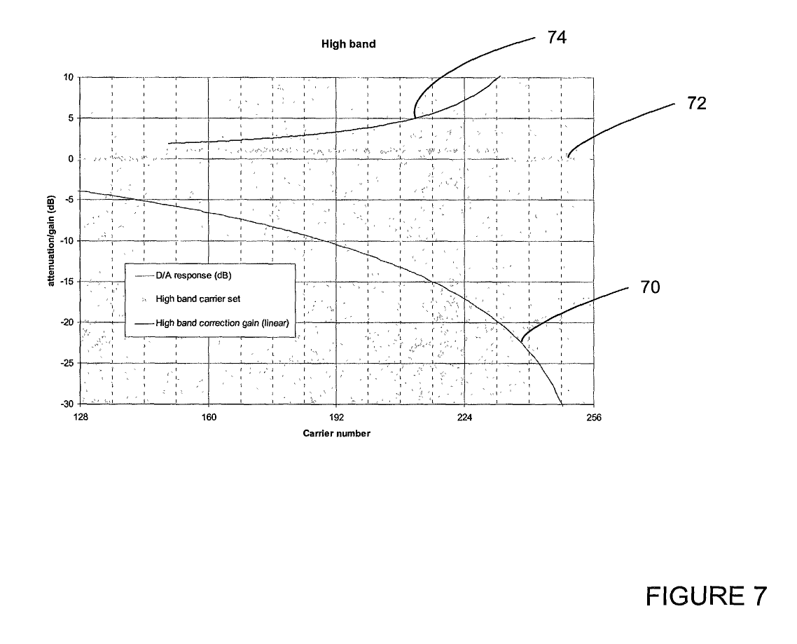

FIG. 7 is a graph showing the D/A converter high band response 70 (in decibels), location of high band carrier set tones 72 and a high band correction gain 74 to be applied for weighting purposes. The high band correction gain 74 shows the gain compensation that can be performed by the weighting stage 506 to compensate for the high band response 70. The weighting can be performed to equalize the power levels of all carriers at the D/A converter output 514. The high band response 70 shows a considerably steeper roll-off than the low band response 60 of FIG. 6. Thus, the high band correction gain 74 is correspondingly steeper than is the low band correction gain 64 (FIG. 6). The actual weighting of complex values depends on the tone positioning performed during the IFFT stage 508. When assigning high-band tone positions the set of carriers is replicated from tone position 150 to tone position 233 of the D/A output signal. However, the order of complex values is reversed. Thus, the largest weight is applied to carrier 23 and the smallest weight is applied to carrier 106 during the weighting stage 506. Those skilled in the art shall recognize that alternative scaling constants may be used for multiplying all of the weights without impacting the desired result of having each carrier have equal power.

In one embodiment of the present invention, the weighting values for low band operation and high band operation (Table 1) are derived from the D/A converter responses shown in FIGS. 6 and 7. In this exemplary embodiment of the present inventive transmitter, the low band weighting values are utilized to weight the complex values corresponding to tone positions 23 to 106 when operating in frequency bands of less than 25 MHz. Similarly, the high band weighting values are utilized to weight the complex values corresponding to tone positions 23 to 106 (in reverse order) when operating in frequency bands greater than 25 MHz. The weighting of complex values is preferably accomplished using weighting multipliers that add weight values to the complex tones. However, one skilled in the art shall recognize that alternative methods can be used without departing from the scope or spirit of the present invention.

In an alternative embodiment, well-known shift-and-add operations are used to perform the weighting function of the weighting stage 506. In an exemplary embodiment, two adders per weight are used for this purpose. In another alternative embodiment, a digital filter is used to perform the weighting function. In this alternative embodiment, the digital filter operates on time domain samples that are output by the IFFT stage.

Referring again to FIG. 5a, the weighting stage 506 outputs the complex and weighted complex values to the input of the inverse fast Fourier transform (IFFT) 508. The IFFT 508 arranges the complex and weighted complex values within its associated frequency word to ensure that output waveform samples are properly formed. In one embodiment, a frequency word is preferably defined as a set of tone positions. The number of tone positions depends upon the size of the frequency word. In the embodiment shown, each frequency word comprises 256 tone positions. One skilled in the art shall recognize that different values can be used for the number of tone positions without departing from the scope or spirit of the present invention. Different types of data values are preferably assigned to various tone positions. In one embodiment, the complex values assigned to the tone positions from n=0 to 22 inclusive are set to zero. The weighted complex values are placed at the tone positions from n=23 to 106 inclusive. The word positions from n=107 to 128 are preferably filled with zeros (i.e., zero filled). To ensure creation of a real-valued waveform, the complex conjugate of the value at position 256-n is preferably assigned to the word positions from n=128 to 255, inclusive. As is well known in the modulation design art, the complex conjugate of a complex value is created simply by inverting the sign of the imaginary part of the complex value. After arranging the frequency word in this manner, the IFFT stage 508 computes an inverse fast Fourier transform in a well-known manner, and thus, transforms the frequency word into a time-domain waveform having a length of 256 samples. The IFFT stage 508 (FIG. 5a) outputs the time-domain waveform to the input of the add cycle prefix stage 510 (FIG. 5a).

As described above with reference to FIG. 3, the add cycle prefix stage 510 preferably lengthens the time-domain waveform by adding a “cyclic prefix”. As is well known in the modulation art, cyclic prefixes are used to combat the detrimental effects of multi-path interference. The present invention adds a cyclic prefix by taking a number of samples from the end of the time-domain waveform and replicating them at the beginning of the waveform. In one embodiment, the last 164 samples of the time-domain waveform are replicated and placed at the beginning of the waveform. Thus, the total waveform length, including the prefix, is preferably 420 samples (i.e., 256+164). The add cycle prefix stage 510 outputs prefix-added waveforms to the input of the parallel-to-serial converter 512.

The parallel-to-serial converter 512 converts the prefix-added waveforms into a serial waveform. The data rate of the serial waveform is 50 MHz in one embodiment. One skilled in the art shall recognize that different data rates can be used with the present invention without departing from its scope or spirit. The parallel-to-serial converter 512 outputs the serial waveform to the input of the digital-to-analog converter 514.

The digital-to-analog (D/A) converter 514 converts the serial waveform to a serial analog waveform. A well-known phenomenon resulting from the conversion of a digital bitstream (e.g., the serial waveform) to an analog signal (e.g., the serial analog waveform) using a D/A converter is the production of “aliases”. Aliases are defined herein as frequency-shifted copies of the fundamental spectrum of the signal centered at multiples of the D/A sampling frequency. In one embodiment, the D/A converter 514 is designed to hold each sample level for a full sample clock period, and thus, the set of frequency-shifted aliases are weighted by a sin(x)/x response that has its nulls at multiples of the D/A sampling frequency. One skilled in the art shall recognize that different frequency responses will result for different D/A converters. Thus, the weighting of the sin(x)/x response described above is not meant to limit the present invention as different weighting responses can be used without departing from the scope of the invention. As shown in FIG. 5a, the D/A converter 514 outputs the serial analog waveform (containing the fundamental signal and a first alias signal) to the input of an anti-alias filter 520.

The anti-alias filter 520 is now described. In one embodiment, the first alias of the fundamental signal begins at 29.3 MHz and extends upward to 45.5 MHz. The present inventive method and apparatus advantageously utilizes both the fundamental signal and the first alias signal to permit use of the transmitter in two operating frequency bands.

When operating in the low band (i.e., using the fundamental signal) a low-pass anti-aliasing filter is used in the anti-alias filter stage 520. In one embodiment, the low-pass anti-alias filter only outputs signals below 25 MHz, for example, the fundamental signal (4.5 to 20.7 MHz). Thus, in this embodiment the anti-alias filter stage 520 outputs the fundamental signal to a line driver and power coupler stage 530.

When operating in the high band (i.e., using the first alias signal) a band-pass anti-aliasing filter is used in the anti-alias filter stage 520. In one embodiment, the band-pass anti-alias filter outputs only signals having frequencies between 25 to 50 MHz, for example, the first alias signal (29.3 to 45.5 MHz). Thus, in this embodiment, the anti-alias filter stage 520 outputs the first alias signal to a line driver and power coupler stage 530.

Depending on the operating mode (low band or high band being used by the present invention), a waveform containing the desired signal (fundamental signal or first alias signal) is output to the input of a line driver and power line coupler stage 530. The line driver and power coupler stage 530 amplifies the desired signal and couples the signal to a power line.

FIG. 5b shows another embodiment of the present inventive OFDM transmitter 500′ made in accordance with the present invention. The embodiment 500′ shown in FIG. 5b is similar to the OFDM transmitter 500 described above with reference to FIG. 5a. Similar components are therefore not described in more detail below. In the embodiment 500′ of FIG. 5b, switching operation between low band and high band is accomplished using a switching means. The switching means directs a desired signal to be provided as input to a low-pass filter for low-band operation, and to a band-pass filter for high-band operation. As shown in the embodiment of FIG. 5b, the transmitter includes a switch 522, a band-pass anti-alias filter 524 and a low-pass anti-alias filter 526. The D/A converter 514 outputs an analog waveform to the input of the switch 522. Depending upon the transmitter operating mode, the switch 522 outputs the analog waveform to either the band-pass anti-alias filter 524 or the low-pass anti-alias filter 526. When operating in low band mode, for example, the switch 522 routes the analog waveform to the input of the low-pass anti-alias filter 526. The low-pass anti-alias filter 526 produces a fundamental signal and provides input to this signal as the line driver and power line coupler 530. When operating in high band mode, the switch 522 routes the analog waveform to the input of the band-pass anti-alias filter 524. The band-pass anti-alias filter 524 produces a first alias frequency signal and provides this signal as input to the line driver and power line coupler stage 530.

Data demodulation is accomplished using an OFDM receiver having an OFDM demodulation operations stage that is selectively detachably coupled to the power line. An embodiment of the inventive OFDM receiver is now described.

OFDM Receiver

The present inventive receiver switches operation from a low-band mode of operation to a high-band mode of operation by switching between use of a low-pass anti-aliasing filter and a band-pass anti-aliasing filter. Additional modifications to existing receiver designs are not required because an OFDM receiver does not have the same weighting problem as does an OFDM transmitter. Weighting is unnecessary in the receiver because the A/D response in the OFDM receivers is not a rectangular pulse. Furthermore, although the ordering of the tones on the power line wire is reversed when the alias is used, the process of sampling at the receiver automatically removes this reversal. Thus, the existing receivers need very little modification in order to be designed to operate in high-band modes.

In one embodiment, when operating in low-band mode (i.e., when operating in frequency bands below 25 MHz), the inventive OFDM receiver includes a low-pass anti-aliasing filter. When operating in the high-band mode (i.e., when operating in frequency bands greater than 25 MHz), the inventive OFDM receiver includes a band-pass anti-aliasing filter.

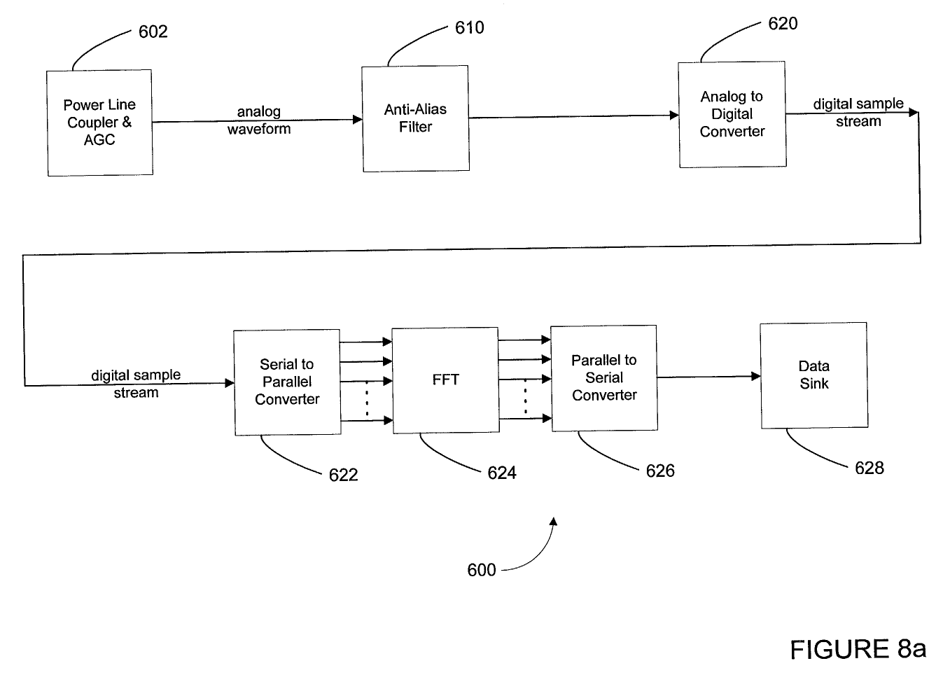

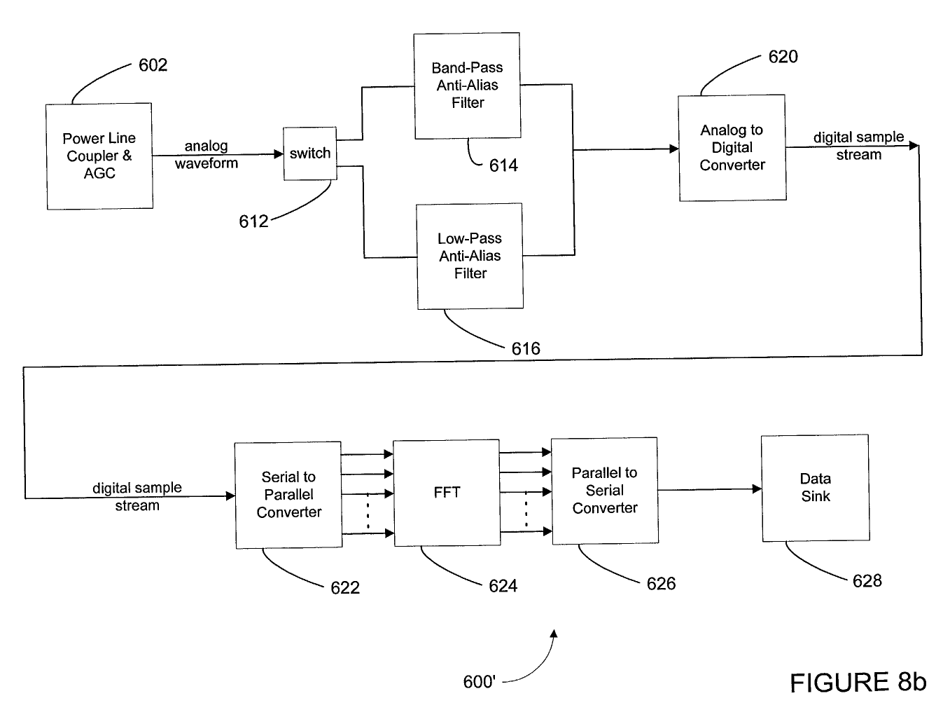

FIG. 8a is a simplified block diagram of one embodiment of an OFDM powerline receiver 600 made in accordance with the present invention. As shown in FIG. 8a, the OFDM powerline receiver 600 comprises a power line coupler and AGC (automatic gain control) stage 602, a demodulation operations stage (comprising processing blocks 610-626), and a data sink 628. The power line coupler and AGC stage 602 couples the power line wire (as described above) to the OFDM receiver 600. The AGC amplifies the input signals across a predetermined dynamic range. Those skilled in the art shall recognize that the AGC is not necessary to practice the present invention. The power line coupler and AGC stage 602 outputs an analog waveform to an anti-alias filter 610.

The anti-alias filter 610 prevents unwanted signal content from being converted by the A/D converter 620. As described above, during analog to digital conversion, a signal sampled by an A/D converter 620 can produce signal content at each frequency of the sampled signal. The sampled signal content at each frequency contains the sum of the signal content at each frequency in the analog waveform, the signal content of the current frequency and the signal content of all multiples of the sampling rate used by the A/D converter. Usually the signal content of the current frequency and the signal content of all multiples of the sampling rate will produce interference. Thus, to prevent degradation of the desired signal, the anti-alias filter 610 is used to suppress signal energy that might be “folded” (i.e., mix) into the desired band.

When operating in the low band (i.e., using the fundamental signal) a low-pass anti-aliasing filter is used in the anti-alias filter stage 610. When operating in the high band (i.e., using the first alias signal) a band-pass anti-aliasing filter is used in the anti-alias filter stage 610. The output of the anti-alias filter 610 is input to an analog to digital (A/D) converter 620 as shown.

The A/D converter 620 converts the analog waveform to a digital sample stream. The A/D converter 620 outputs the digital sample stream to the input of a serial-to-parallel (S/P) converter 622. The S/P converter 622 converts the digital sample stream into a parallel set of samples. The S/P converter 622 outputs the parallel set of samples to the input of a fast Fourier Transform (FFT) stage 624. The FFT stage 624 computes a fast Fourier transform in a well-known manner to obtain frequency domain values. These frequency domain values are output to the input of a parallel-to-serial (P/S) converter 626. The P/S converter 626 converts the parallel input signals to a serial signal. The P/S converter 626 outputs the received bits in the serial signal to the input of the data sink 628.

FIG. 8b shows another embodiment of the present inventive OFDM receiver 600′ made in accordance with the present invention. The embodiment 600′ of the present invention shown in FIG. 8b is similar to the OFDM receiver 600 described above with reference to FIG. 8a. Similar components are not described in more detail below. In the embodiment 600′ of FIG. 8b, the switching operation between the low band and high band is accomplished using a switching means. The switching means directs a desired signal to be provided as input to either a low-pass filter (for low-band operations) or a band-pass filter (for high-band operations).

As shown in FIG. 8b, the receiver 600′ uses a switch 612, a band-pass anti-alias filter 614 and a low-pass anti-alias filter 616. The power line coupler and AGC stage 602 outputs an analog waveform to the input of the switch 612. Depending upon the operating mode being used by the receiver 600′, the switch 612 outputs the analog waveform to the input of either the band-pass anti-alias filter 614 or the low-pass anti-alias filter 616. When operating in a low band mode, the switch 612 routes the analog waveform to the low-pass anti-alias filter 616. The low-pass anti-alias filter 616 outputs a filtered signal to the A/D converter 620. When operating in a high band mode, the switch 616 routes the analog waveform to the band-pass anti-alias filter 614. The band-pass anti-alias filter 614 outputs a filtered signal to the A/D converter 620. The OFDM receiver 600′ demodulates the filtered signal in a manner described above with reference to FIG. 8a.

Summary

In summary, the present invention is a method and apparatus for dual-band modulation in powerline networking systems. The inventive method and apparatus utilizes a transmitter and a receiver that can operate in different modulation frequency bands. The present invention can easily switch between operating frequency bands by using a fundamental signal for modulating in a first frequency band and by using a first alias signal for modulating in a second frequency band. The present inventive method and apparatus can switch between operation in a first frequency band to a second frequency band by slightly modifying only two components of existing OFDM transmitters and by modifying only one component in existing OFDM receivers. Advantageously, therefore, the present invention can be utilized with existing powerline networking technology.

A few embodiments of the present invention have been described. Nevertheless, it will be understood that various modifications may be made without departing from the spirit and scope of the invention. For example, the present inventive method and apparatus can weight complex values utilizing weighting multipliers. Alternatively, a shift-and-add operation can be used to weight the complex values without departing from the scope of the present invention.

What is claimed is:

1. A dual-band modulation AC powerline networking circuit, comprising:
(a) an input node for receiving a digital frequency-domain input signal;
(b) an IFFT circuit, adapted to receive the digital frequency-domain input signal, wherein the IFFT circuit generates a digital time-domain signal responsive to the frequency-domain input signal;
(c) a digital-to-analog converter circuit, adapted to receive the digital time-domain signal, wherein the digital-to-analog converter generates an analog time-domain signal; and
(d) an anti-aliasing filter, adapted to receive the analog time-domain signal, wherein the anti-aliasing filter outputs an analog filtered signal responsive to a selected operating frequency band.

2. The dual-band networking circuit of claim 1, wherein the anti-aliasing filter operates in a first selected operating frequency band to generate a fundamental signal, and wherein the anti-aliasing filter operates in a second selected operating frequency band to generate a first alias signal.

3. The dual-band networking circuit of claim 2, wherein the anti-aliasing filter comprises:
(a) a low-pass anti-alias filter adapted to receive the analog time-domain signal, wherein the low-pass filter operates in the first selected operating frequency band to generate the fundamental signal;
(b) a band-pass anti-alias filter adapted to receive the analog time-domain signal, wherein the band-pass filter operates in the second selected operating frequency band to generate the first alias signal; and
(c) a switch element adapted to switch operation between the low-pass filter and the band-pass filter.

4. The dual-band networking circuit of claim 2, wherein the first selected operating frequency band comprises frequencies less than or equal to approximately 25 MHz and the second selected operating frequency band comprises frequencies ranging approximately between 25 MHz and 50 MHz.

5. The dual-band networking circuit of claim 2, wherein the first selected operating frequency band comprises frequencies ranging approximately between 4 MHz and 21 MHz and the second selected operating frequency band comprises frequencies ranging approximately between 29 MHz and 46 MHz.

6. The dual-band networking circuit of claim 1, wherein the IFFT circuit includes a weighting circuit adapted to receive the frequency-domain input signal, and wherein the weighting circuit generates a first weighted signal based upon a first set of weighting values and a second weighted signal based upon a second set of weighting values.

7. The dual-band networking circuit of claim 6, wherein the weighting circuit further includes a plurality of weighting multipliers wherein the multipliers are adapted to utilize the first set of weighting values in generating the first weighted signal and utilize the second set of weighting values in generating the second weighted signal.

8. The dual-band networking circuit of claim 6, wherein the weighting circuit includes a plurality of shift-and-add operators wherein the operators are adapted to utilize the first set of weighting values in generating the first weighted signal and utilize the second set of weighting values in generating the second weighted signal.

9. The dual-band networking circuit of claim 8, wherein the plurality of shift-and-add operators include at least two adders per weighting value.

10. The dual-band networking circuit of claim 6, wherein the weighting circuit includes first and second digital filters, and wherein the first filter generates the first weighted signal based upon the first set of weighting values, and wherein the second filter generates the second weighted signal based upon the second set of weighting values.

11. The dual-band networking circuit of claim 6, wherein the IFFT circuit further includes a frequency word assembler adapted to assign a plurality of complex values to selected tone positions and generate a frequency word, and wherein the frequency word includes a plurality of tone positions.

12. The dual-band networking circuit of claim 11, wherein the frequency word includes 256 tone positions.

13. The dual-band networking circuit of claim 12, wherein the plurality of complex values comprises a plurality of unweighted complex values and a plurality of weighted complex values.

14. The dual-band networking circuit of claim 13, wherein the frequency word comprises a first set of tone positions having zero values, a second set of tone positions having weighted complex values, and a third set of tone positions having complex conjugate values.

15. The dual-band networking circuit of claim 6, wherein the weighting circuit is adapted to weight the frequency-domain input signal in accordance with a sin(x)/x response, and wherein the sin(x)/x response has nulls at multiples of a D/A sampling frequency.

16. The dual-band networking circuit of claim 1, wherein the IFFT circuit includes a serial-to-parallel converter, and wherein the serial-to-parallel converter receives the digital frequency-domain input signal and generates a parallel digital frequency-domain signal responsive to the input signal.

17. The dual-band networking circuit of claim 1, wherein the digital-to-analog converter circuit includes an add cycle prefix circuit that adds a cyclic prefix to a time-domain waveform signal, and wherein the digital-to-analog converter also includes a parallel-to-serial converter circuit wherein the parallel-to-serial converter receives parallel digital frequency-domain signals and generates a serial waveform signal.

18. The dual-band networking circuit of claim 17, wherein the digital-to-analog converter circuit holds a sample level for a full sample clock period.

19. The dual-band networking circuit of claim 17, wherein the serial waveform signal comprises a 50 MHz data rate signal.

20. The dual-band networking circuit of claim 1, wherein the anti-aliasing filter includes a line driver and a power line coupler circuit, wherein the line driver amplifies an anti-alias signal, and wherein the power line coupler electrically couples the anti-alias signal to a power line.

21. The dual-band networking circuit of claim 20, further including an input circuit, wherein the input circuit receives the analog filtered signal and generates a digital data signal.

22. The dual-band networking circuit of claim 21, wherein the input circuit includes a second anti-alias filter, wherein the second filter receives the analog filtered signal and generates a second analog filtered signal responsive to the selected operating frequency band.

23. A method of performing dual-band modulation in an AC powerline communication network system, comprising the steps of:
(a) inputting a digital frequency-domain input signal;
(b) generating a digital time-domain signal responsive to the frequency-domain input signal;
(c) converting the digital time-domain signal into an analog signal;
(d) selecting an operating frequency band; and
(e) selectively filtering the analog signal responsive to the selected operating frequency band thereby generating a filtered signal.

24. The method of performing dual-band modulation in an AC powerline communication network system of claim 23, wherein the selective filtering step (e) comprises filtering the analog signal to produce a fundamental signal for a first selected operating frequency band.

25. The method of performing dual-band modulation in an AC powerline communication network system of claim 23, wherein the selective filtering step (e) comprises filtering the analog signal to produce a first alias signal for a second selected operating frequency band.

26. The method of performing dual-band modulation in an AC powerline communication network system of claim 24, wherein the selective filtering step (e) comprises low-pass filtering.

27. The method of performing dual-band modulation in an AC powerline communication network system of claim 25, wherein the selective filtering step (e) comprises band-pass filtering.

28. The method of performing dual-band modulation in an AC powerline communication network system of claims 24 and 25, wherein the first selected operating frequency band comprises frequencies less than or equal to approximately 25 MHz and the second selected operating frequency band comprises frequencies ranging approximately between 25 MHz and 50 MHz.

29. The method of performing dual-band modulation in an AC powerline communication network system of claims 24 and 25, wherein the first selected operating frequency band comprises frequencies ranging approximately between 4 MHz and 21 MHz and the second selected operating frequency band comprises frequencies ranging approximately between 29 MHz and 46 MHz.

30. The method of performing dual-band modulation in an AC powerline communication network system of claim 23, wherein the generating step (b) includes performing an inverse fast Fourier transformation to generate the digital time-domain signal.

31. The method of performing dual-band modulation in an AC powerline communication network system of claim 23, wherein the generating step (b) comprises the sub-steps of:
(1) weighting the input signal; and
(2) performing inverse fast Fourier transformations to generate the digital time-domain signal.

32. The method of performing dual-band modulation in an AC powerline communication network system of claim 31, wherein the weighting sub-step (1) comprises weighting the input signal with a first set of weighting values for operation in a first frequency band to generate a first weighted signal.

33. The method of performing dual-band modulation in an AC powerline communication network system of claim 31, wherein the weighting sub-step (1) comprises weighting the input signal with a second set of weighting values for operation in a second frequency band to generate a second weighted signal.

34. A dual-band modulation AC powerline networking circuit, comprising:
(a) input means for inputting a digital frequency-domain input signal;
(b) transformation means, operatively coupled to and responsive to the input means, for generating a digital time-domain signal based upon the input signal;
(c) digital-to-analog converter means, operatively coupled to and responsive to the transformation means, for converting the digital time-domain signal into an analog signal; and
(d) filter means, operatively coupled to and responsive to the digital-to-analog converter means, for filtering the analog signal, wherein the filter means generates a filtered signal responsive to a selected frequency band.

35. The dual-band modulation AC powerline networking circuit of claim 34, wherein the filter means comprises a low-pass filtering means for filtering the analog signal to generate a fundamental signal for a first selected frequency band.

36. The dual-band modulation AC powerline networking circuit of claim 34, wherein the filter means comprises a band-pass filtering means for filtering the analog signal to generate a first alias signal for a second selected frequency band.

37. An AC powerline networking apparatus having an input node, comprising:
(a) input means for receiving a digital frequency-domain input signal from an input node;
(b) weighting means, operatively coupled to and responsive to the input means, for weighting a digital time-domain signal based upon a selected frequency band;
(c) transformation means, operatively coupled to and responsive to the weighting means, for generating a digital time-domain signal based upon the input signal;
(d) digital-to-analog converter means, operatively coupled to and responsive to the transformation means, for converting the digital time-domain signal into an analog signal; and
(e) filtering means, operatively coupled to and responsive to the digital-to-analog converter means, for filtering the analog signal responsive to a selected frequency band to generate a filtered signal.

38. The AC powerline networking apparatus of claim 37, wherein the weighting means comprises a first weighting means for weighting the input signal to generate a first weighted signal for a first selected frequency band.

39. The AC powerline networking apparatus of claim 37, wherein the weighting means comprises a second weighting means for weighting the input signal to generate a second weighted signal for a second selected frequency band.

40. A dual-band modulation AC powerline receiver, comprising:
(a) a powerline coupler generating an analog input signal;
(b) an anti-aliasing filter, adapted to receive the analog input signal, wherein the anti-aliasing filter outputs an analog filtered signal responsive to a selected operating frequency band;
(c) an analog-to-digital converter (ADC) circuit, adapted to receive the analog filtered signal, wherein the ADC generates a digital time-domain signal nominally equivalent to the analog filtered signal;
(d) a serial-to-parallel converter having an input coupled to the ADC, wherein the serial-to-parallel converter converts the digital time-domain signal into a parallel digital signal;
(e) a fast-Fourier Transform (FFT) adapted to receive the parallel digital signal from the serial-to-parallel converter, wherein the FFT computes a fast Fourier transform and generates a parallel digital frequency-domain signal representative of the digital time-domain signal; and
(f) a parallel-to-serial converter coupled to the FFT, wherein the parallel-to-serial converter converts the parallel digital frequency-domain signal into a serial frequency-domain digital signal.

41. The dual-band modulation AC powerline receiver of claim 40, wherein the anti-aliasing filter operates in a first selected operating frequency band to filter a fundamental signal, and wherein the anti-aliasing filter operates in a second selected operating frequency band to filter a first alias signal.

42. The dual-band modulation AC powerline receiver of claim 41, wherein the anti-aliasing filter comprises:
(a) a low-pass anti-alias filter adapted to receive the analog input signal, wherein the low-pass filter operates in the first selected operating frequency band to filter the fundamental signal;
(b) a band-pass anti-alias filter adapted to receive the analog input signal, wherein the band-pass filter operates in the second selected operating frequency band to filter the first alias signal; and
(c) a switch element adapted to switch operation between the low-pass filter and the band-pass filter.

43. A method of receiving data in a dual-band modulation AC powerline communication network system, comprising the steps of:
(a) receiving an analog input signal;
(b) selecting an operating frequency band;
(c) selectively filtering the analog input signal responsive to the selected operating frequency band thereby generating an analog filtered signal;
(d) converting the analog filtered signal into a digital time-domain signal nominally equivalent to the analog filtered signal;
(e) converting the digital time-domain signal into a parallel digital signal, performing a fast-Fourier Transform on the converted parallel digital signal to generate a digital frequency-domain signal representative of the digital time-domain signal, converting the frequency-domain signal into a serial frequency-domain digital signal; and
(f) outputting the serial frequency-domain digital signal to a data sink.

44. The method of receiving data in a dual-band modulation AC powerline communication network system of claim 43, wherein the selective filtering step (c) comprises filtering the analog input signal for a fundamental signal of a first selected operating frequency band.

45. The method of receiving data in a dual-band modulation AC powerline communication network system of claim 43, wherein the selective filtering step (c) comprises filtering the analog signal for a first alias signal of a second selected operating frequency band.

46. The method of receiving data in a dual-band modulation AC powerline communication network system of claim 43, wherein the selective filtering step (c) comprises low-pass filtering.

47. The method of receiving data in a dual-band modulation AC powerline communication network system of claim 43, wherein the selective filtering step (c) comprises band-pass filtering.

48. The method of receiving data in a dual-band modulation AC powerline communication network system of claims 44 and 45, wherein the first selected operating frequency band comprises frequencies less than or equal to approximately 25 MHz and the second selected operating frequency band comprises frequencies ranging approximately between 25 MHz and 50 MHz.
